(19) United States
(12) Patent Application Publication
(10) Pub. No.: US 2013/0054734 A1
(43) Pub. Date: Feb. 28, 2013

(54) MIGRATION OF CLOUD APPLICATIONS BETWEEN A LOCAL COMPUTING DEVICE AND CLOUD

(71) Applicants: Barry Clayton Bond, Redmond, WA (US); Reuben R. Olinsky, Seattle, WA (US); Galen C. Hunt, Bellevue, WA (US)

(72) Inventors: Barry Clayton Bond, Redmond, WA (US); Reuben R. Olinsky, Seattle, WA (US); Galen C. Hunt, Bellevue, WA (US)

(73) Assignee: Microsoft Corporation, Redmond, WA (US)

(21) Appl. No.: 13/215,244

(22) Filed: Aug. 23, 2011

(51) Int. Cl. G06F 15/16

(52) U.S. Cl. 709/217

(57) ABSTRACT

Architecture that facilitates seamless migration of server-hosted code to the client machine and back. Migration is of a running instance of a process by communicating only a small amount of state data, which makes this feasible over current network connection speeds. The web browsing experience for applications is retained. The migration capabilities are facilitated by an operating construction, referred to as the library OS (operating system) system in a context of state and execution migration between server and client. An application binary interface is provided that resides below the library OS to provide the state and execution mobility.

### BACKGROUND

Different types of applications such as spreadsheet applications, presentation applications, and word processing application can be accessed using a web browser that navigates to web-based servers. The same applications can also be hosted in collaboration sites. The user experience is that of a web browser where the document and the application both appear entirely in the web browser, with no download or installation required. When using such web applications, the user is oblivious to server-side events, such as server reboots or load balancing--the application simply runs.

However, if the network connection between the browser and the cloud breaks, the browser-hosted application quickly becomes unusable. For instance, the user can continue to scroll around inside a spreadsheet while offline, but if the user scrolls too far, an error message dialogs such as “An error has occurred trying to perform the requested action. Please try again. [OK]” may be generated. Options for how to address this problem have been limited, and essentially redefine the application so it is no longer a web application to execute the application entirely on the client machine.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture facilitates seamless migration of server-hosted code to the client machine and back. Migration is of a running instance of a process by communicating only a small amount of data, which makes this feasible over current network (e.g., the Internet) connection speeds. The web browsing experience for applications is retained.

The migration capabilities are facilitated by an operating construction, referred to as the library OS (operating system) system in a context of state and execution migration between server and client. The library OS operates with a significantly reduced overhead (e.g., several megabytes) than a virtual machine monitor (e.g., hundreds of megabytes). An application binary interface (ABI) is provided that resides below the library OS to provide the state and execution mobility.

Isolation provides for a level of mutual mistrust--a way for users to host executable code downloaded from the web onto the user machine without the trust requirement usually needed for remote execution of code, and a way for code to run on the user machine in a robust way, resilient against misconfigured operating systems, botched installs, etc.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates a more detailed description of a migration system.

FIG. 3 illustrates an exemplary migration component system implementation in the context of a Windows operating system.

FIG. 4 illustrates a system that embodies the migration technology where connectivity is reliable between a client machine and a datacenter.

FIG. 5 illustrates the system that now embodies the migration technology where connectivity has failed between the client machine and the datacenter.

FIG. 6 illustrates a method in accordance with the disclosed architecture.

FIG. 7 illustrates further aspects of the method of FIG. 6.

FIG. 8 illustrates an alternative method in accordance with the disclosed architecture.

FIG. 9 illustrates further aspects of the method of FIG. 8.

FIG. 10 illustrates a block diagram of a computing system that executes migration processing in accordance with the disclosed architecture.

### DETAILED DESCRIPTION

The disclosed architecture is a migration component as a light-weight virtual machine that isolates existing applications from each other and from the host operating system (OS) kernel. The architecture provides the capability to quickly “hibernate” the in-memory state of an application out to disk, and to resume from hibernation on the same or even a different computer. The size of the hibernation state is small (e.g., typically a megabyte or two).

When a user visits a certain website and opens a document in the browser, at least two operations can take place in the background. On the cloud servers in the cloud, an instance of an application is invoked to quickly render the document into bitmap tiles, which are easy for the web browser to consume. These support read-only viewing of documents, and efficient pan/scroll through documents.

In a first aspect, the instance of the application is transient--its job is to render the document, and then move on (it is not part of a long-running interaction scenario with the user).

In a second aspect, an instance of the application is created to support interactive editing. The document is loaded, and then sits waiting for input from the user, submitted by script code that runs in the browser. Rather than transmitting raw keyboard and mouse input one-by-one, the script in the browser aggregates these fine-grain operations into coarser-grained “UX (user experience) transactions”, such as editing the contents of a cell in a spreadsheet. The edits all happen entirely in the browser, and only when the cell is ready to commit are the contents of the cell finalized.

The disclosed architecture modifies the second aspect--the long-running application instance associated with the user/document. The server-side application can fail and restart almost seamlessly, as the application sits passively waiting for the browser to submit these coarse-grained UX transactions. Except for the actual processing of a UX transaction (applying it to the in-memory document, and writing the updated document back out to durable storage), the application may go down and come back up without the user noticing.

However, if the network connection between browser and cloud is intermittent or completely goes down, that next UX transaction sent from browser to cloud will error out. Moreover, the browser-side code has few options for recovery: try again, or notify the user of the broken connection. Either way, until the network returns, the browser application is essentially unusable.

A solution is to employ the migration component to run the instance of the application inside a virtual machine. Accordingly, the server-side of the migration component and its contained application execute in the cloud on server(s), while the browser-side code works unmodified, and the user sees no interruption. However, if the user knows the connection is unreliable and will be dropped or if the network connection slows or becomes unreliable, the disclosed migration component activates to migrate the server-side application instance to the user's local computer using hibernate/resume technology. The application continues to run hosted in a web server, but is now an instance running on the local computer. The browser and its script code continue to work as-is, except that the web requests are directed to the locally-executing instance of the application rather than the cloud-hosted application. Thereafter, when the network connection is restored, the locally-executing instance writes its durable document up to the cloud storage, and then uses migration to move execution back to the cloud.

To enable this feature, users can first download and install the monitor, library OS and application on their client machine. The installation does not use the registry (it is essentially xcopy-deploy) and can be self-updating after the first install.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

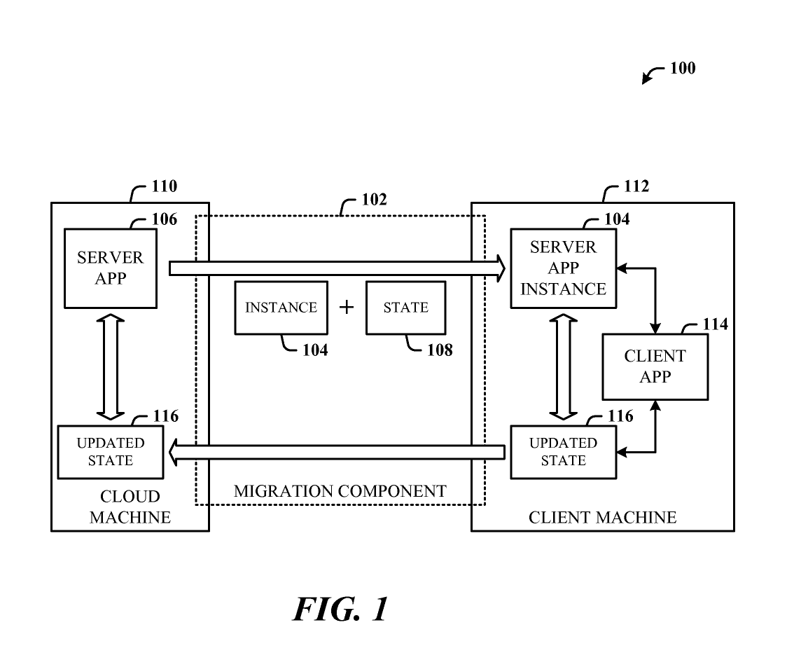

FIG. 1 illustrates a system 100 in accordance with the disclosed architecture. The system 100 includes a migration component 102 that facilitates migration of an instance 104 of a server-hosted application 106 and associated server application state 108 from a cloud machine 110 to a client machine 112. The instance 104 is then implemented in execution on the client machine 112. A client application 114 of the client machine 112 operates against the instance 104 to create client application state (referred to as updated state 116). The migration component 102 migrates the update state 116 from the client machine 112 to the cloud machine 110 to operate with the server-hosted application 106.

The migration process can be triggered manually or automatically. For example, if the client user perceives that the connection between the cloud machine 110 and client machine 112 is unreliable (e.g., interruptions, speed degradation, etc.), the user can initiate the migration process, and thereafter, work in an offline mode. Once the user determines that the connection is once again reliable, the user can initiate the migration process from the client machine 112 back to the cloud (cloud machine 110).

The migration process can be triggered automatically as a background process based on detection that the connection is becoming unreliable. Thus, the user may simply be given a notification that the user is now working in the offline mode, and once the connection is re-established as reliable, the user can again be notified that the user is now working in an online mode.

The migration component 102 performs the migration when a connection between the client machine 112 and the cloud machine 110 becomes unreliable and then becomes reliable. As described in detail herein below, the migration component 102 includes a refactored monolithic operating system kernel as a library, and an application binary interface (ABI) that separates the library from a host operating system. The ABI enables the host operating system to expose virtualized resources to the library. The server-hosted application 106 runs in a virtual machine on the cloud machine 110 and the instance 104 runs in a virtual machine of the client machine 112.

The library interacts with the host operating system via an ABI implemented by a platform adaptation layer and a security monitor. The security monitor enforces external policies that govern host operating system resources available to the client application. The server application state 108 is stored in manifest files for migration between the cloud machine and the client machine. The migration component 102 employs streams for input/output. The migration component 102 interfaces to a high-level user shell via a web browser protocol and web browser, and a low-level operating system kernel.

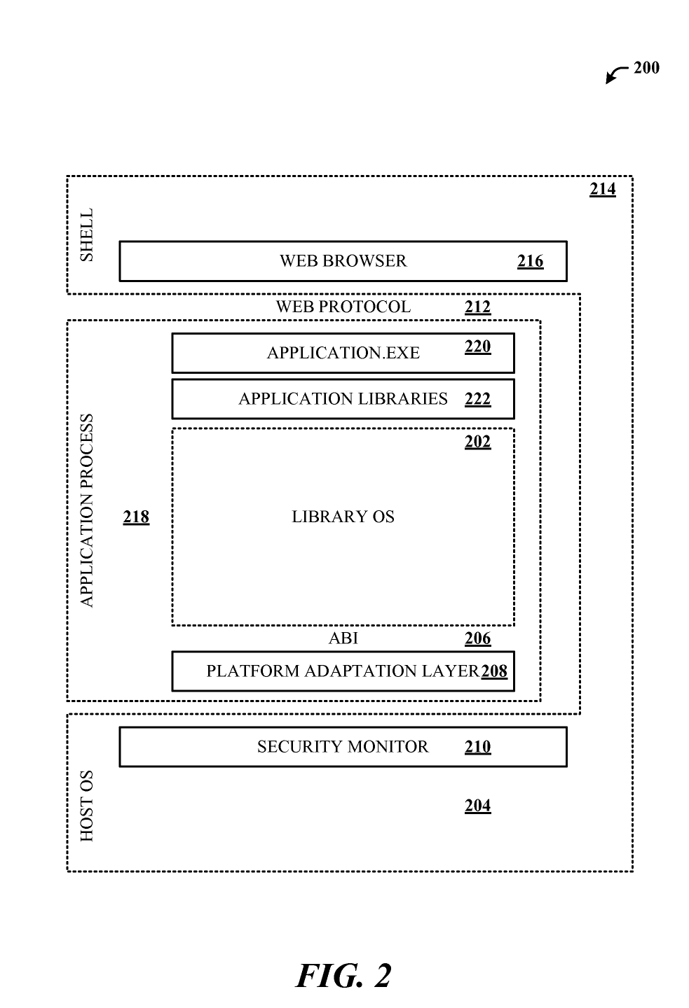

FIG. 2 illustrates a more detailed description of a migration system 200. Generally, server-side applications are accessed via a browser, and application renders itself using a web protocol (e.g., HTML+Javascript, or some other modern web protocol), and the shell client is a web browser. The migration system 200 approach prioritizes application compatibility and high-level OS (operating system) code reuse, and avoids low-level management of the underlying hardware by a library OS 202 (also referred to generally as the library). The migration system utilizes a small set of OS abstractions—threads, virtual memory, and I/O streams—which are sufficient to host the library OS 202, and a rich set of applications. This small set of abstractions simplifies protection of system integrity, mobility of applications and, independent evolution of the library OS and the underlying kernel components. Despite being strongly isolated, applications can still share resources, including the screen, keyboard, mouse, and user clipboard, across independent library OS 202 instances through the pragmatic reuse of networking protocols.

As a structuring principle, three categories of services in OS implementations are identified: hardware services, user services, and application services. (Note that the description herein focuses implementation using a Windows operating system by Microsoft Corporation; however, in a more general application, the architecture can apply just as well to other operating systems suitably parsed at least along hardware, user, and application service components.)

Hardware services can include the OS kernel and device drivers, which abstract and multiplex hardware, along with file systems and TCP/IP (transmission control protocol/ Internet protocol) network stack. User services in the OS include the graphical user interface (GUI) shell and desktop, clipboard, search indexers, etc. Application services in the OS include an API (application program interface) implementation; to an application, these comprise the OS personality. Application services include frameworks, rendering engines, common UI (user interface) controls, language runtimes, etc. The application communicates with application services, which in turn communicate with hardware services and user services.

In the instant description, these service categories are utilized to drive the refactoring of Windows into the library OS 202. The migration component employs application services into the library OS 202 and leaves user and hardware services in the host OS 204. The library OS 202 communicates with hardware services in the host OS 204 through the narrow ABI 206, which is implemented by a platform adaptation layer 208 and a security monitor 210. The library OS 202 communicates with user services in the host OS 204 using a web protocol (e.g., HTML plus Javascript) tunneled through the ABI 206. Each application (e.g., application.exe) runs in its own address space with its own copy of the library OS 202.

The security monitor 210 virtualizes host OS 204 resources through its ABI 206 with the library OS 202 and maintains a consistent set of abstractions across varying host OS implementations. For example, the file system seen by an application is virtualized by the security monitor 210 from file systems in the host OS 204. A shell 214 includes a web browser client 216. As shown, an application process 218 (isolated) includes the library OS 202, an application program 220, and associated application binaries 222. The application process 218 also includes the platform adaptation layer 208 for interfacing through the ABI 206 to the library OS 202.

The disclosed migration component employs goals such as security, host independence, and migration, which free it to offer higher-level abstractions. These higher-level abstractions make it easier to share underlying host OS resources such as buffer caches, file systems, and networking stacks with the library OS. By making low-level resource management an independent concern from OS personality, each can evolve more aggressively.

A conventional virtual machine (VM) monitor is a mechanism for automatically treating a conventional OS as a library OS; however, the facility incurs significant overheads. Each isolated application runs in a different dedicated VM, each of which is managed by a separate OS instance. The OS state in each VM leads to significant storage overheads. For example, one existing guest OS consumes 512 MB of RAM and 4.8 GB of disk. In contrast, the disclosed migration component refactors the guest OS to extract only those APIs needed by the application, adding less than 16 MB of working set and 64 MB of disk.

The disclosed approach can significantly impact desktop computing by enabling fine-grain packaging of self-contained application. The finer-grained, higher-performance application and OS packages that are now possible with library operating systems precipitate similar shifts in desktop and mobile computing, for example, snapshots of running migration applications can easily move from device to device and to the cloud because of the associated size is so small.

As disclosed generally herein, a first refactoring of a widely used monolithic OS into a functionally-rich library OS is described. Disclosed is a set of heuristics for refactoring a monolithic kernel into a library, as well as the ABI for separating a library OS from host OS. The benefits of this design include: strong encapsulation of the host OS from the library OS, enabling rapid and independent evolution of each; migration of running state of individual applications across computers; and improved protection of system and application integrity (strongly isolated processes).

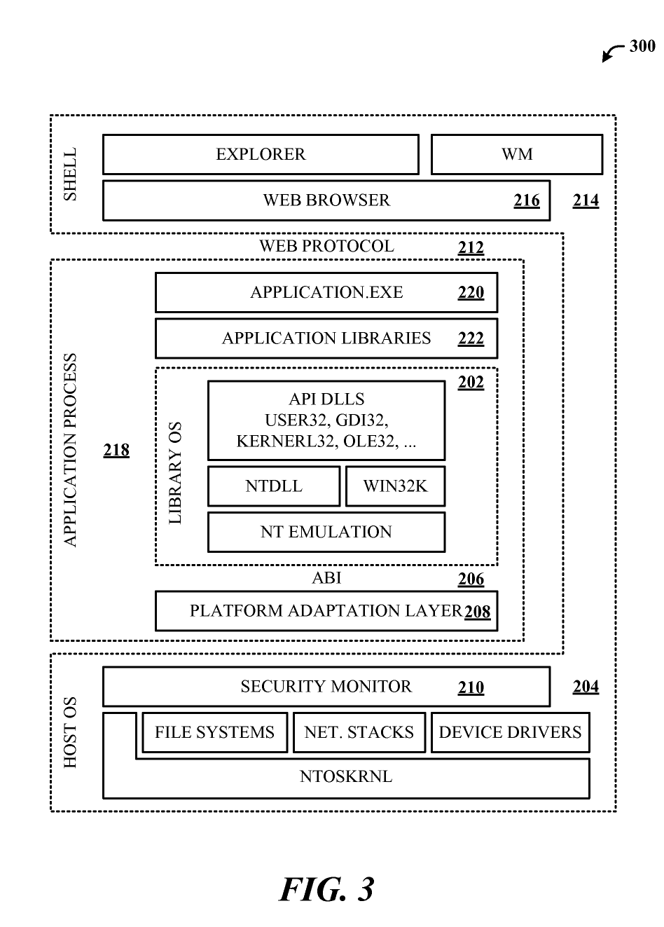

FIG. 3 illustrates an exemplary migration component system 300 implementation in the context of a Windows operating system. As described generally above, these service categories are utilized to drive the refactoring of Windows into the library OS 202. The migration component employs application services into the library OS 202 and leaves user and hardware services in the host OS 204. The library OS 202 communicates with hardware services in the host OS 204 through the narrow ABI 206, which is implemented by the platform adaptation layer 208 (dkpal) and the security monitor 210 (dkmon).

The shell 214 includes the web browser 216 that communicates with the application process 218 via the web protocol 212. The shell 214 can also include, in this particular implementation, Explorer™ (a Windows browser program) and Windows manager (WM) (e.g., DWM (Desktop Window Manager)). As shown, the application process 218 (isolated) includes the library OS 202, which further includes an NT emulation layer, ntdll, win32k, API DLLS, user32, dgi32, kernel32, ole32, etc., which are described below. The host OS 204 includes the security monitor 210, file systems, net stacks, device drivers, and the OS kernel (ntoskrnl).

To maximize application compatibility while minimizing dependencies outside the library OS, a Windows™ OS is (e.g., Windows 7) can be refactored by applying four high-level heuristics: inclusion of API DLLs (dynamic link libraries) based on usage in a representative set of applications, reuse of virtualized host OS resources, resolution of dependencies through inclusion or alternative implementations, and device driver emulation. In a library OS, the library OS state is not shared by multiple applications or users.

A first heuristic identifies the API DLLs used by a representative set of applications. Static analysis can be utilized on the application binaries to approximate the set of API DLLs, and then the set can be refined with dynamic instrumentation by monitoring DLL load operations issued during test runs.

For kernel-mode dependencies, a second heuristic implements an NT (New Technology™) kernel emulation layer at the bottom of the library OS. This emulation layer is thin, since many complex parts of a kernel—e.g., threading, virtual memory, file system, and networking—are provided by the host OS through the security monitor. The security monitor virtualizes host resources according to a well-defined high-level ABI, independent of host OS version. Other parts of the library OS are simpler because multi-user multiplexing is no longer required. For this reason, the migration component registry implementation has significantly fewer lines of code of than the Windows OS equivalent.

A third heuristic addresses dependencies on service daemons and the Windows subsystem, by either moving code into the library OS, or altering the API DLL to remove the dependency. In one implementation, code can be included where most of the service was relevant when running a single application, and code can be replaced where it was needlessly complicated by the security or consistency demands of supporting multiple applications and/or multiple users. For example, most of win32k and rpcss can be included as these services provide core functionality for applications. By contrast, custom library OS code can be written to replace csrss, smss, and wininit, which primarily aid cross-application sharing of state.

A fourth heuristic addresses console and human interface device dependencies by providing emulated device drivers. Keyboard and mouse drivers used by the Windows subsystem can be emulated with stub drivers that provide simple input queues, and the display driver emulated with a stub driver that draws to an in-process frame buffer. Input/output (I/O) from the emulated devices is tunneled to the desktop and the user through web protocol connections.

The library OS interacts with the host OS through the ABI, which is implemented by the security monitor. The ABI is designed to provide a small set of functions with well-defined semantics easily supported across a wide range of host OS implementations. The ABI's design enables the host OS to expose virtualized resources to the library OS with minimal duplication of effort. Following is a description of the ABI followed by an exemplary implementation of the security monitor.

In providing the ABI, the security monitor enforces a set of external policies governing the host OS resources available to the application. Policies can be encoded in manifest files associated with the application. The manifest whitelists the host OS resources that an application may access, identified by a URI (uniform resource identifier) path. The manifest can also be used as a place to store per-application configuration settings.

In this particular implementation, the ABI includes three calls to allocate, free, and modify the permission bits on page-based virtual memory. Permissions can include read, write, execute, and guard. Memory regions can be unallocated, reserved, or backed by committed memory:

VOID *DkVirtualMemoryAlloc(Addr, Size, AllocType, Prot);
DkVirtualMemoryFree(Addr, Size, FreeType);
DkVirtualMemoryProtect(Addr, Size, Prot);

The ABI supports multithreading through five calls to create, sleep, yield the scheduler quantum for, resume execution of, and terminate threads, as well as seven calls to create, signal, and block on synchronization objects:

DKHANDLE DkThreadCreate(Addr, Param, Flags);
DkThreadDelayExecution(Duration);
DkThreadYieldExecution( );
DkThreadResume(ThreadHandle);
DkThreadExit( );
DKHANDLE DkSemaphoreCreate(InitialCount, MaxCount);
DKHANDLE DkNotificationEventCreate(InitialState);
DKHANDLE DkSynchronizationEventCreate(InitialState);
DkSemaphoreRelease(SemaphoreHandle, ReleaseCount);
BOOL DkEventSet(EventHandle);
DkEventClear(EventHandle);
ULONG DkObjectsWaitAny(Count, HandleArray, Timeout);

A primary I/O mechanism in the disclosed migration component technology is an I/O stream. I/O streams are byte streams that may be memory-mapped or sequentially accessed. Streams are named by URIs. The stream ABI can include nine calls to open, read, write, map, unmap, truncate, flush, delete and wait for I/O streams and three calls to access metadata about an I/O stream. The ABI purposefully does not provide an ioctl call. Supported URI schemes include file:, pipe:, http:, https:, tcp:, udp:, pipe.srv:, http.srv:, tcp.srv:, and udp.srv:. The latter four schemes are used to open inbound I/O streams for server applications:

DKHANDLE DkStreamOpen(URI, AccessMode, ShareFlags,

CreateFlags, Options);

ULONG DkStreamRead(StreamHandle, Offset, Size, Buffer);
ULONG DkStreamWrite(StreamHandle, Offset, Size, Buffer);
DkStreamMap(StreamHandle, Addr, ProtFlags, Offset, Size);
DkStreamUnmap(Addr);
DkStreamSetLength(StreamHandle, Length);
DkStreamFlush(StreamHandle);
DkStreamDelete(StreamHandle);
DkStreamWaitForClient(StreamHandle);
DkStreamGetName(StreamHandle, Flags, Buffer, Size);
DkStreamAttributesQuery(URI, DK_STREAM_ATTRIBUTES *Attr);
DkStreamAttributesQueryByHandle(StreamHandle,

DK_STREAM_ATTRIBUTES *Attr);

The ABI includes one call to create a child process and one call to terminate the running process. A child process does not inherit any objects or memory from its parent process and the parent process may not modify the execution of its children. A parent can wait for a child to exit using its handle. Parent and child may communicate through I/O streams provided by the parent to the child at creation:
DKHANDLE DkProcessCreate(URI, Args, DKHANDLE *FirstThread); DkProcessExit(ExitCode);

Finally, the ABI includes seven assorted calls to get wall clock time, generate cryptographically-strong random bits, flush portions of instruction caches, increment and decrement the reference counts on objects shared between threads, and to coordinate threads with the security monitor during process serialization:

LONG64 DkSystemTimeQuery( );
DkRandomBitsRead(Buffer, Size);
DkInstructionCacheFlush(Addr, Size);
DkObjectReference(Handle);
DkObjectClose(Handle);
DkObjectsCheckpoint( );
DkObjectsReload( );

The brevity (e.g., 17K lines of code (LoC) in a security monitor) of the ABI enables tractable coding-time and run-time review of its isolation boundary. It is to be appreciated that the ABI can be coded smaller; however, a slightly larger ABI (e.g., a dozen more calls) makes it easier to port existing code and makes the ported code easier to maintain. For example, rather than exposing semaphores, notification events, and synchronization events, only a single synchronization primitive need be exposed. The slightly larger ABI allows the security monitor to implement virtualized resources with resources that the host OS can more efficiently support.

The ABI can be implemented through two components: the security monitor, dkmon, and the platform adaptation layer, dkpal. The primary job of dkmon is to virtualize host OS resources into the application while maintaining the security isolation boundary between the library OS and the host OS. Although implementations of dkmon and dkpal vary across different host systems, these components are responsible for maintaining strict compatibility with the ABI specification.

A migration component process accesses the ABI by calling dkpal. Following are three implementations of dkpal: the first, requires no changes to the host OS kernel, and uses four host OS calls to issue requests over an anonymous named pipe to dkmon; the second, replaces the NT system-call service table on a per-process basis using techniques developed for Xax (a browser plug-in for developers to build rich applications using existing tools); and the third, makes Hyper-V (a product that implements type 1 hypervisor virtualization) hypercalls.

The security monitor dkmon services ABI requests by modifying the address space and host OS handle table of the calling process with standard Windows cross-process manipulation APIs (e.g., ReadProcessMemory, VirtualAllocEx, VirtualFreeEx, and DuplicateHandle). As an optimization, dkpal implements a few simple ABI calls (e.g., blocking wait, thread yield) by directly invoking compatible, host OS system calls; this is safe, as the migration process cannot create host OS handles. In one implementation, the platform adaptation layer dkpal calls a number (e.g., fifteen) of distinct host OS system calls. In another implementation, the data paths dkmon can be moved into the host kernel to avoid the cost of a complete address space change to service some ABI calls, and to harden the boundary around the migration processes.

The security monitor dkmon uses host NT threads and synchronization objects—semaphores, notification events, and synchronization events—to implement the scheduling objects exposed through the ABI. As a result, migration component threads reside in the host kernel's scheduling queues and avoid unnecessary scheduling overheads.

I/O streams are used by the library OS to implement higher-level abstractions such as files, sockets, and pipes. The security monitor filters access to I/O streams by URI based on a manifest policy; where access is allowed, it directs I/O to the mapped resources. This indirection enables run-time configuration of the application's virtual environment, and prevents applications from inadvertently or maliciously accessing protected resources within the host system's file namespace. Unless overridden, the monitor's default policy only allows a process to access files within the same host directory as its application image.

As an example, the library OS leverages I/O streams to emulate NT file objects and named pipe objects, as well as a proxied interface to networking sockets. In the latter case, the library OS includes a minimal version of ws2_{—}32 that use I/O streams identified by tcp: and udp: URIs. The security monitor backs these streams with sockets provided by the host system's ws2_{—}32. In one implementation, the disclosed migration technology provides improved isolation by offering an IP-packet stream interface and moving the implementation of TCP and UDP into the library OS.

Library OS Process Bootstrap. To create a migration process the security monitor dkmon uses the host OS's native facilities to create a suspended process containing a bootstrap loader (dkinit). Every NT process is created with the ntdll library mapped copy-on-write, because the kernel uses fixed offsets in the library as up-call entry points for exceptions. Before allowing a new process to execute, dkmon maps its own dkntdll library into the new process's address space and overwrites upcall entry points in the host-provided ntdll with jumps to dkntdll, eviscerating ntdll to a jump table and replacing it as the dynamic loader. dkmon writes a parameter block into the new process's address space to communicate initialization parameters, such as a reference to the pipe to be used for communication with dkmon. dkmon then resumes the suspended process, with execution starting in ntdll and immediately jumping to dkntdll, which sets up initial library linkage (to itself) and transfers control to dkinit. dkinit invokes dkntdll to initialize the win32k library (described next) and to load the application binary and its imported libraries. When loading is complete, dkinit jumps to the application's entry point.

Win32k Bootstrap. Converting win32k from a kernel subsystem to a user-mode library requires reformulating its complicated, multi-process initialization sequence. In standard Windows, first, the single, system-wide instance of win32k is initialized in kernel mode. Second, wininit initiates the preloading of win32k's caches with shared public objects such as fonts and bitmaps. Because win32k makes upcalls to the user32 and gdi32 user-mode libraries to load an object into its cache, these libraries must be loaded before filling the cache. Third, when a normal user process starts, it loads its own copies of user32 and gdi32, which connect to win32k and provide GUI services.

The disclosed approach simulates the full win32k bootstrapping sequence within a single process. Entry points are exported from win32k, user32, and gdi32, which are called by dkinit for each of the boot steps.

On a full Windows system, csrss creates a read-only, shared-memory segment to share cached bitmaps and fonts, which is replaced in the library OS with heap allocated objects, since all components that access it now share the same address space and protection domain. The upcalls that previously stressed the win32k initialization sequence are removed, and the corresponding complexity can be reduced. Likewise, many other access checks over shared state are removed from win32k, and the Windows logon session abstraction, wininit, and csrss are eliminated.

Emulating NT kernel Interfaces. To support binary compatibility with existing Windows (e.g., Windows 7) API DLLs, user-mode implementations of approximately 150 NT kernel system calls are provided. The majority of these functions are stubs that either trivially wrap the ABI (e.g., virtual memory allocation, thread creation, etc.), return static data, or always return an error (e.g., STATUS_NOT_IMPLEMENTED).

The remaining system calls produce higher-level NT abstractions, such as files, locks, and timers, built entirely inside the library OS using migration technology primitives. Compatible semantics are also built for the NT I/O model, including synchronous and asynchronous I/O, “waitable” file handles, completion ports, and asynchronous procedure calls.

Shared System Services. Windows applications can depend on shared system services, accessible either through system calls or IPCs to trusted service daemons. These include services such as the Windows registry and OLE (object linking and embedding). In order to confine the state and dependencies of migration processes, the library OS implements the functionality of several such services using two design patterns: providing simple alternate implementations of service functionality, and hosting extant library code in-process.

Alternative Implementations. Many Windows system services are backed by complex and robust implementations, tuned and hardened for a wide variety of use cases. For a few such services like the registry, the services' advertised interfaces are re-implemented within the library OS rather than to port existing implementations.

The registry is a system-wide, hierarchical, key-value store, accessible to Windows processes through system calls. The traditional Windows registry is implemented in kernel mode; its complexity implements fine-grained access control and locking as well as transactional semantics. The library OS includes a private, in-process reimplementation of the registry, significantly simpler than the shared kernel registry. The NT emulation layer supplies a simple interface to this implementation, with coarse locking and no support for transactions.

Importing Implementations. In several cases, some shared Windows services can be ported largely intact. For example, supporting COM (component object model) is utilized for rich applications in Windows; a significant number of desktop- and server-class applications are formed by composing multiple COM objects through the OLE protocol.

Refactoring COM followed the same basic pattern used with other system services: shared, out-of-process components were ported to run privately in-process and bound directly to application-side libraries. For example, a component of OLE is the running object table (ROT), which provides inter- and intra-process name resolution for COM objects. While only one instance of the ROT is maintained per system within rpcss, in the disclosed migration component, ROT runs directly within the application process and only manages local objects.

Process Serialization. The volatile state associated with a traditional Windows process is distributed across the NT kernel and kernel-mode drivers; shared, out-of-process, user-mode service daemons; and the process's own address space. Serializing the running state of a Windows process would normally require the careful cooperation of each of these components, and significant changes to the OS. However, with migration technology process isolation, a process' transient state is either confined to pages in its address space or can be reconstructed from data maintained within its address space.

Serializing a migration process is can be accomplished given the design of ABI and the library OS. Running win32k as a user-mode library reduces the amount of kernel state associated with the process. The remaining out-of-process state includes resources managed by the host OS, such as files and synchronization objects. To account for this, the ABI inserts indirection between system objects and host NT system objects. This distinction enables the library OS to unbind and rebind these objects at deserialization time. Since the metadata for host kernel objects are stored within a process address space, serialization only requires quiescing the threads and serializing the contents of the address space. The thread contexts need not be serialized, as the active register contents are stored on their stacks during quiescence. The application serializes itself with no involvement from the host, beyond the I/O stream to which the serialized state is saved.

In order to quiesce the threads within a migration process, the security monitor signals a notification event to indicate a serialization request. Threads blocked on ABIs are awakened via the notification event, outstanding I/O requests are completed, and other threads are interrupted with an exception. Once notified of the pending serialization, all threads, except one, yield indefinitely. The final thread begins serializing the process to a monitor-provided I/O stream, recording virtual memory bookkeeping information and the contents of the process address space. Files on which the process depends are migrated with the application or accessed through a distributed file system. Network sockets are terminated on migration causing applications to reestablish their network connections. In a world of migrating laptops, the applications are robust to network interruptions. After serialization is complete, the yielding threads are awakened and the process continues normal execution.

Reconstructing a process from its serialized state employs adjustments to its initialization sequence. Rather than loading the application binary, serialized virtual memory data are used to restore the contents of the process address space, including heap and stack memory as well as memory-mapped I/O streams. Code in dkpal rebinds host system objects to ABI objects without involvement from the library OS or the application. After recreating the process, the threads quiesced during serialization are unblocked and continue normal execution.

Two possible designs for multi-process applications, particularly for applications that communicate through shared state in win32k, as is done in many OLE scenarios, load multiple applications into a single address space or run win32k in a separate user-mode server process that can be shared by multiple applications in the same isolation container.

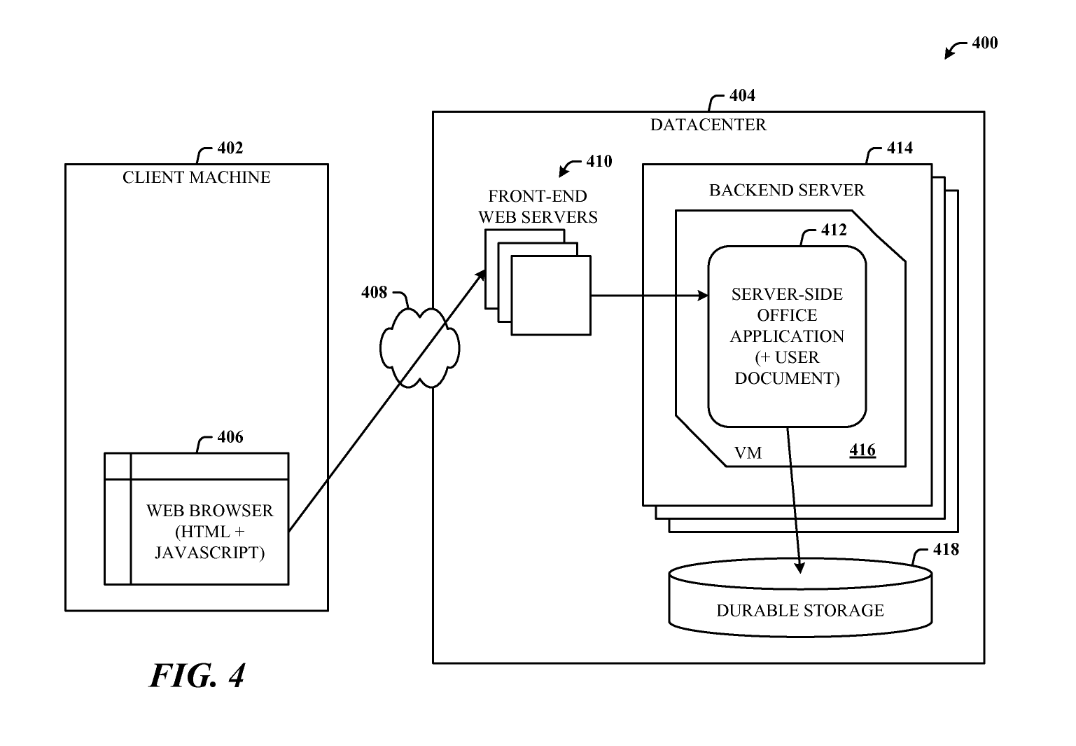

FIG. 4 illustrates a system 400 that embodies the migration technology where connectivity is reliable between a client machine 402 and a datacenter 404. The client machine 402 (e.g., client machine 112) includes a browser 406 that communicates through a network 408 (e.g., the Internet) to frontend servers 410, and then to a server-side application 412 (e.g., server app 104) of a backend server 414 of the datacenter 404. The server-side application 412 (e.g., office suite type) runs in a virtual machine 416, and stores its document in a durable storage 418.

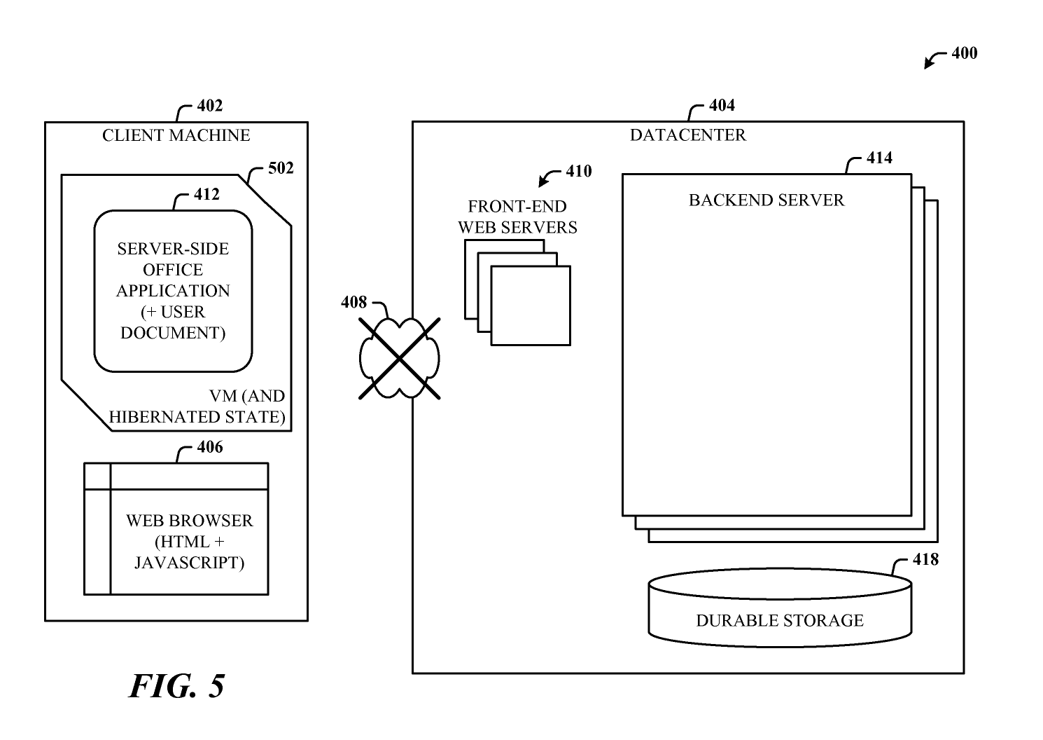

FIG. 5 illustrates the system 400 that now embodies the migration technology where connectivity has failed between the client machine 402 and the datacenter 404. When determining (e.g., sensing) that the network 408 is about to fail, the backend server 414 hibernates its state data, and ships its hibernated state data to a virtual machine 502 the client machine 402. An instance of the server-side application 412 is also shipped to the client-side VM 502. The VM 502 provides the isolated environment in which the server-side application 412 runs using the hibernated state data. The browser 406 runs against the locally-hosted server-side application 412 until the connection 408 is re-established, at which time the client machine 402 hibernates the most recent state of the VM 412, and ships the state and server-side application 412 back to the backend server 414 to run.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

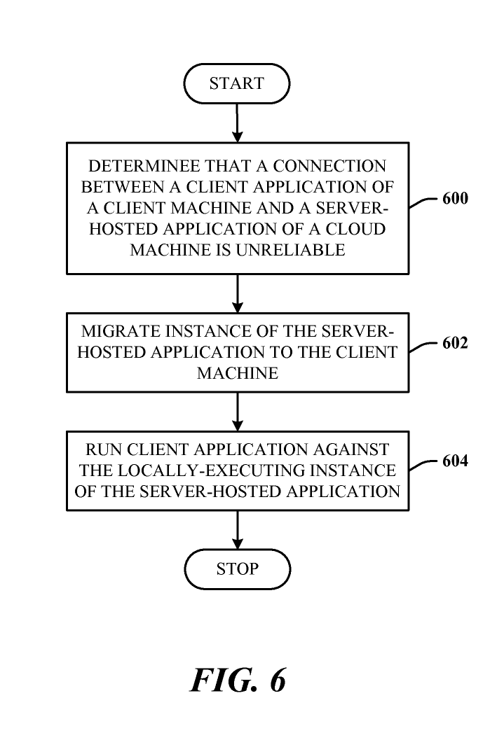

FIG. 6 illustrates a method in accordance with the disclosed architecture. At 600, it is determined that a connection between a client application of a client machine and a server-hosted application of a cloud machine is unreliable. At 602, an instance of the server-hosted application is migrated to the client machine. At 604, the client application is run against the locally-executing instance of the server-hosted application.

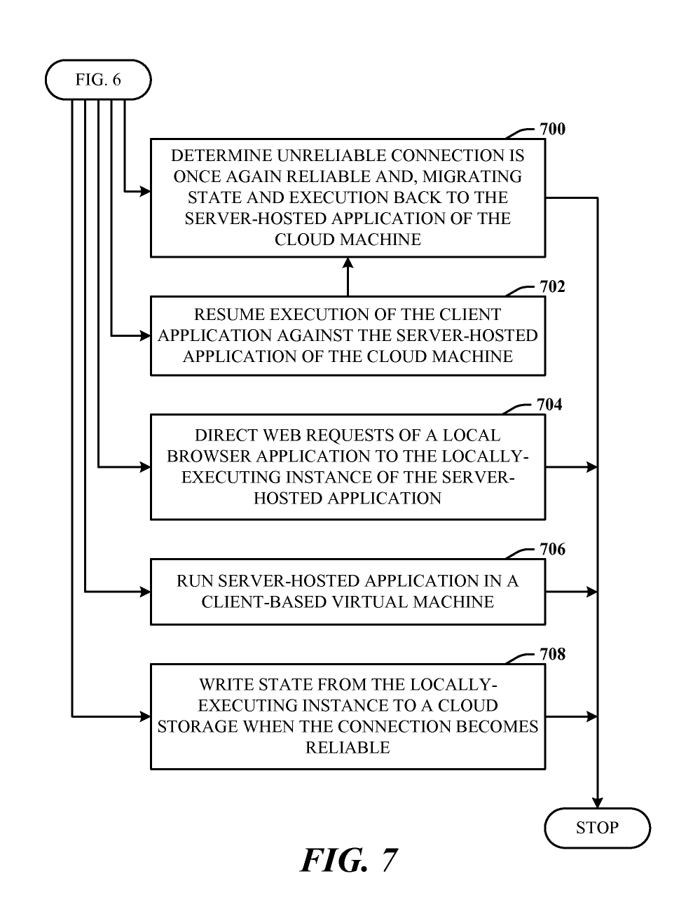

FIG. 7 illustrates further aspects of the method of FIG. 6. Note that the flow indicates that each block can represent a step that can be included, separately or in combination with other blocks, as additional aspects of the method represented by the flow chart of FIG. 6. At 700, the unreliable connection is determined to once again reliable and, the state and execution are migrated back to the server-hosted application of the cloud machine. At 702, execution of the client application is resumed against the server-hosted application of the cloud machine. At 704, web requests of a local browser application are directed to the locally-executing instance of the server-hosted application. At 706, the server-hosted application is run in a client-based virtual machine. At 708, state is written from the locally-executing instance to a cloud storage when the connection becomes reliable.

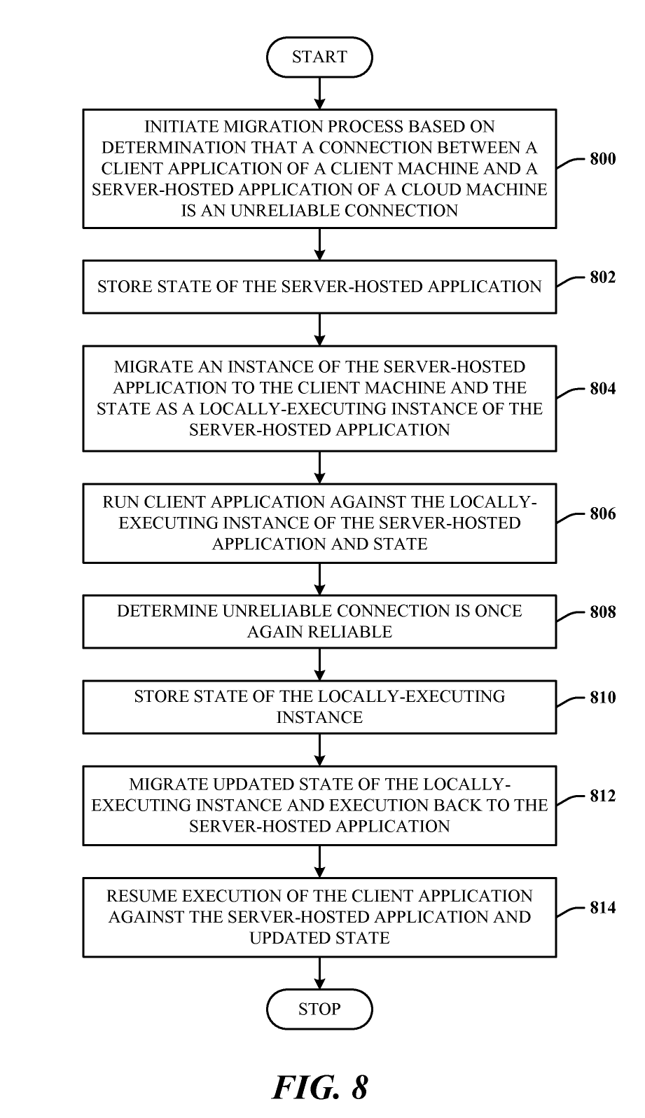

FIG. 8 illustrates an alternative method in accordance with the disclosed architecture. At 800, a migration process is initiated based on determination that a connection between a client application of a client machine and a server-hosted application of a cloud machine is an unreliable connection. At 802, state of the server-hosted application is stored. At 804, an instance of the server-hosted application and associated state is migrated to the client machine as a locally-executing instance of the server-hosted application. At 806, the client application is run against the locally-executing instance of the server-hosted application and state. At 808, the unreliable connection is determined to once again be reliable. At 810, state of the locally-executing instance is stored. At 812, updated state of the locally-executing instance and execution are migrated back to the server-hosted application. At 814, execution of the client application resumes against the server-hosted application and updated state (of the cloud machine).

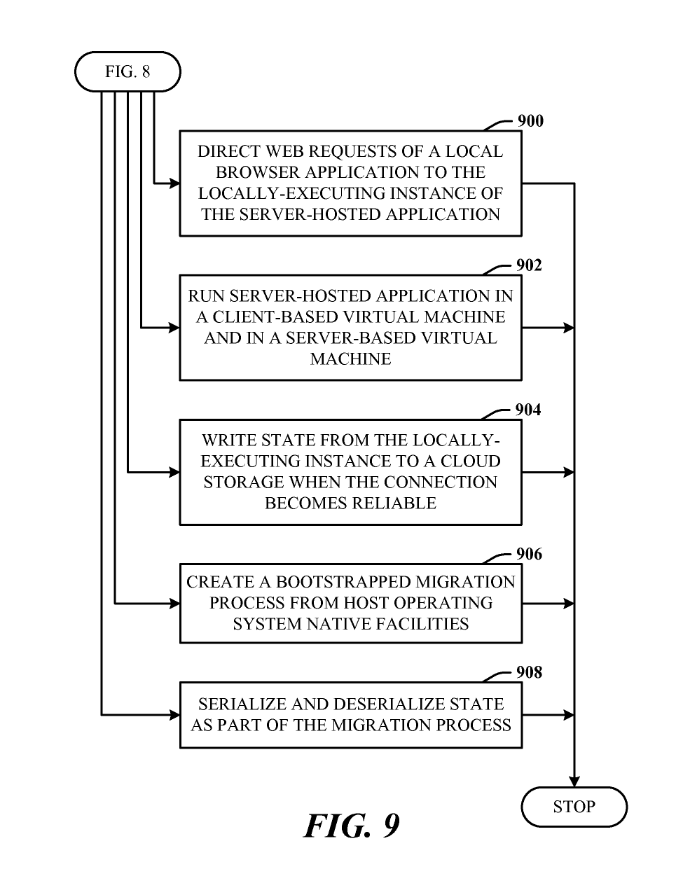

FIG. 9 illustrates further aspects of the method of FIG. 8. Note that the flow indicates that each block can represent a step that can be included, separately or in combination with other blocks, as additional aspects of the method represented by the flow chart of FIG. 8. At 900, web requests of a local browser application are directed to the locally-executing instance of the server-hosted application. At 902, the server-hosted application is run in a client-based virtual machine and in a server-based virtual machine. At 904, state from the locally-executing instance is written to a cloud storage when the connection becomes reliable. At 906, a bootstrapped migration process is created from host operating system native facilities. At 908, the state is serialized and deserialized as part of the migration process.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

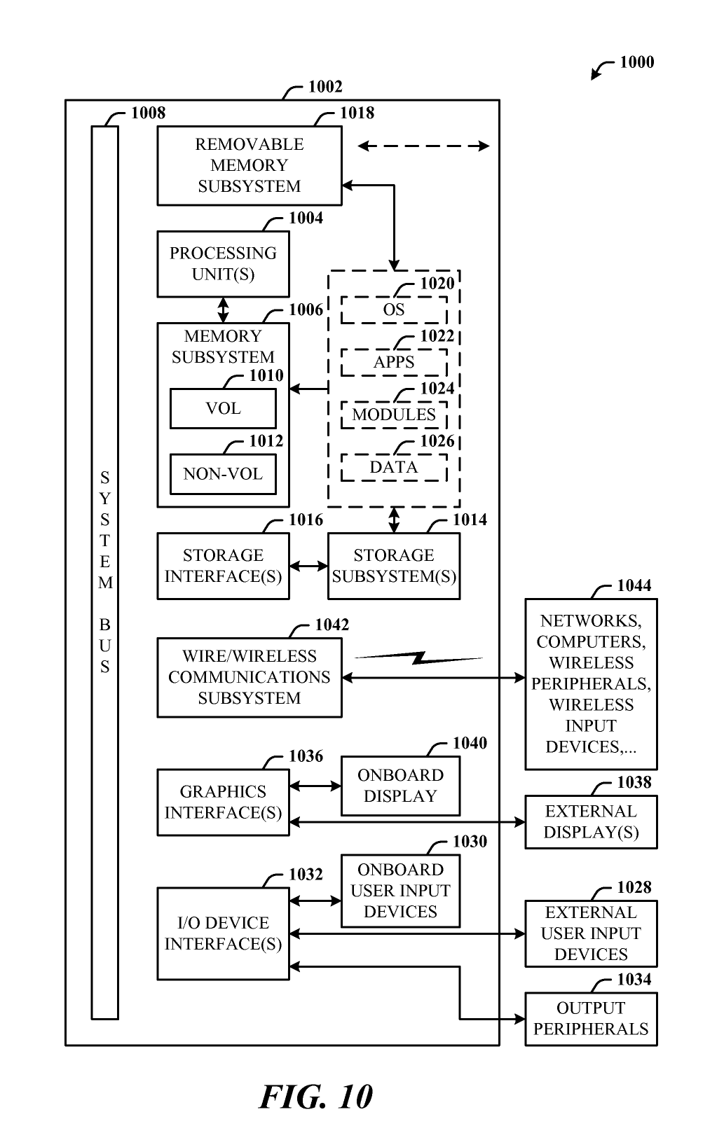

Referring now to FIG. 10, there is illustrated a block diagram of a computing system 1000 that executes migration processing in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 10 and the following description are intended to provide a brief, general description of the suitable computing system 1000 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1000 for implementing various aspects includes the computer 1002 having processing unit(s) 1004, a computer-readable storage such as a system memory 1006, and a system bus 1008. The processing unit(s) 1004 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1006 can include computer-readable storage (physical storage media) such as a volatile (VOL) memory 1010 (e.g., random access memory (RAM)) and non-volatile memory (NON-VOL) 1012 (e.g., ROM, EPROM, EEPROM, etc.). A basic input/output system (BIOS) can be stored in the non-volatile memory 1012, and includes the basic routines that facilitate the communication of data and signals between components within the computer 1002, such as during startup. The volatile memory 1010 can also include a high-speed RAM such as static RAM for caching data.

The system bus 1008 provides an interface for system components including, but not limited to, the system memory 1006 to the processing unit(s) 1004. The system bus 1008 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1002 further includes machine readable storage subsystem(s) 1014 and storage interface(s) 1016 for interfacing the storage subsystem(s) 1014 to the system bus 1008 and other desired computer components. The storage subsystem(s) 1014 (physical storage media) can include one or more of a hard disk drive (HDD), a magnetic floppy disk drive (FDD), and/or optical disk storage drive (e.g., a CD-ROM drive DVD drive), for example. The storage interface(s) 1016 can include interface technologies such as EIDE, ATA, SATA, and IEEE 1394, for example.

One or more programs and data can be stored in the memory subsystem 1006, a machine readable and removable memory subsystem 1018 (e.g., flash drive form factor technology), and/or the storage subsystem(s) 1014 (e.g., optical, magnetic, solid state), including an operating system 1020, one or more application programs 1022, other program modules 1024, and program data 1026.

The operating system 1020, one or more application programs 1022, other program modules 1024, and/or program data 1026 can include entities and components of the system 100 of FIG. 1, entities and components of the system 200 of FIG. 2, entities and components of the system 300 of FIG. 3, entities and components of the system 400 of FIG. 4, entities and components of the system 400 of FIG. 5, and the methods represented by the flowcharts of FIGS. 6-9, for example.

Generally, programs include routines, methods, data structures, other software components, etc., that perform particular tasks or implement particular abstract data types. All or portions of the operating system 1020, applications 1022, modules 1024, and/or data 1026 can also be cached in memory such as the volatile memory 1010, for example. It is to be appreciated that the disclosed architecture can be implemented with various commercially available operating systems or combinations of operating systems (e.g., as virtual machines).

The storage subsystem(s) 1014 and memory subsystems (1006 and 1018) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 1002 and includes volatile and non-volatile internal and/or external media that is removable or non-removable. For the computer 1002, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 1002, programs, and data using external user input devices 1028 such as a keyboard and a mouse. Other external user input devices 1028 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1002, programs, and data using onboard user input devices 1030 such a touchpad, microphone, keyboard, etc., where the computer 1002 is a portable computer, for example. These and other input devices are connected to the processing unit(s) 1004 through input/output (I/O) device interface(s) 1032 via the system bus 1008, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1032 also facilitate the use of output peripherals 1034 such as printers, audio devices, camera devices, and so on, such as a sound card and/or onboard audio processing capability.

One or more graphics interface(s) 1036 (also commonly referred to as a graphics processing unit (GPU)) provide graphics and video signals between the computer 1002 and external display(s) 1038 (e.g., LCD, plasma) and/or onboard displays 1040 (e.g., for portable computer). The graphics interface(s) 1036 can also be manufactured as part of the computer system board.

The computer 1002 can operate in a networked environment (e.g., IP-based) using logical connections via a wired/wireless communications subsystem 1042 to one or more networks and/or other computers. The other computers can include workstations, servers, routers, personal computers, microprocessor-based entertainment appliances, peer devices or other common network nodes, and typically include many or all of the elements described relative to the computer 1002. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1002 connects to the network via a wired/wireless communication subsystem 1042 (e.g., a network interface adapter, onboard transceiver subsystem, etc.) to communicate with wired/wireless networks, wired/wireless printers, wired/wireless input devices 1044, and so on. The computer 1002 can include a modem or other means for establishing communications over the network. In a networked environment, programs and data relative to the computer 1002 can be stored in the remote memory/storage device, as is associated with a distributed system. It will be appreciated that the network connections shown are exemplary and other means of establishing a communications link between the computers can be used.

The computer 1002 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system, comprising:
a migration component performs migration of an instance of a server-hosted application and associated server application state from a cloud machine to a client machine, a client application of the client machine operates against the instance to create client application state, the migration component performs migration of the client application state from the client machine to the cloud machine to operate with the server-hosted application; and
a processor that executes computer-executable instructions associated with at least the migration component.

2. The system of claim 1, wherein the migration component performs the migration when a connection between the client machine and the cloud machine becomes unreliable and then becomes reliable.

3. The system of claim 1, wherein the migration component includes a refactored monolithic operating system kernel as a library, and an application binary interface (ABI) that separates the library from a host operating system.

4. The system of claim 3, wherein the ABI enables the host operating system to expose virtualized resources to the library.

5. The system of claim 1, wherein the server-hosted application runs in a virtual machine on the cloud machine and the instance runs in a virtual machine of the client machine.

6. The system of claim 1, wherein the library interacts with the host operating system via an ABI implemented by a platform adaptation layer and a security monitor, the security monitor enforces external policies that govern host operating system resources available to the client application.

7. The system of claim 1, wherein the server application state is stored in manifest files for migration between the cloud machine and the client machine.

8. The system of claim 1, wherein the migration component interfaces to a high-level user shell via a web browser protocol and web browser, and a low-level operating system kernel.

9. A computer-implemented method, comprising acts of:
determining that a connection between a client application of a client machine and a server-hosted application of a cloud machine is unreliable;
migrating an instance of the server-hosted application to the client machine;
running the client application against the locally-executing instance of the server-hosted application; and
utilizing a processor that executes instructions stored in memory to perform at least one of the acts of determining, migrating, or running

10. The method of claim 9, further comprising determining the unreliable connection is once again reliable and, migrating state and execution back to the server-hosted application of the cloud machine.

11. The method of claim 10, further comprising resuming execution of the client application against the server-hosted application of the cloud machine.

12. The method of claim 9, further comprising directing web requests of a local browser application to the locally-executing instance of the server-hosted application.

13. The method of claim 9, further comprising running the server-hosted application in a client-based virtual machine.

14. The method of claim 9, further comprising writing state from the locally-executing instance to a cloud storage when the connection becomes reliable.

15. A computer-implemented method, comprising acts of:
initiating a migration process based on determination that a connection between a client application of a client machine and a server-hosted application of a cloud machine is an unreliable connection;
storing state of the server-hosted application;
migrating an instance of the server-hosted application to the client machine and the state as a locally-executing instance of the server-hosted application;
running the client application against the locally-executing instance of the server-hosted application and state;
determining the unreliable connection is once again reliable;
migrating updated state of the locally-executing instance and execution back to the server-hosted application;
resuming execution of the client application against the server-hosted application and updated state; and
utilizing a processor that executes instructions stored in memory to perform at least one of the acts of determining or migrating.

16. The method of claim 15, further comprising directing web requests of a local browser application to the locally-executing instance of the server-hosted application.

17. The method of claim 15, further comprising running the server-hosted application in a client-based virtual machine and in a server-based virtual machine.

18. The method of claim 15, further comprising writing state from the locally-executing instance to a cloud storage when the connection becomes reliable.

19. The method of claim 15, further comprising creating a bootstrapped migration process from host operating system native facilities.

20. The method of claim 15, further comprising serializing and deserializing state as part of the migration process.
